(19) United States
(12) Patent Application Publication
(10) Pub. No.: US 2014/0038700 A1
(43) Pub. Date: Feb. 6, 2014

(54) GAMING SYSTEM AND METHOD

(71) Applicants: Anthony Scott Oddo, Quincy, MA (US); Warren E. Tolman, Watertown, MA (US)

(72) Inventors: Anthony Scott Oddo, Quincy, MA (US); Warren E. Tolman, Watertown, MA (US)

(21) Appl. No.: 13/957,028

(22) Filed: Aug. 1, 2013

Related U.S. Application Data
(60) Provisional application No. 61/678,414, filed on Aug. 1, 2012.
(60) Provisional application No. 61/678,408, filed on Aug. 1, 2012.
(60) Provisional application No. 61/678,393, filed on Aug. 1, 2012.
(60) Provisional application No. 61/750,514, filed on Jan. 9, 2013.

(51) Int. Cl. G07F 17/32

(52) U.S. Cl. CPC G07F 17/3244
USPC 463/25

(57) ABSTRACT

A method, computer program product, and computing system for defining a side bet between a first participant having made a first selection in a lottery game and a second participant having made a second selection in the lottery game, wherein the side bet has a bet value. The first selection is compared to the second selection to identify a winner of the side bet and a loser of the side bet. The bet value is obtained from the loser of the side bet. At least a portion of the bet value is provided to the winner of the side bet

### RELATED APPLICATIONS

This application claims the benefit of the following U.S. Provisional Patent Application Ser. Nos. 61/678,414, filed 1 Aug. 2012; 61/678,408, filed 1 Aug. 2012; 61/678,393, filed 1 Aug. 2012; and 61/750,514, filed 9 Jan. 2013, their entire contents of which are incorporated herein by reference.

### TECHNICAL FIELD

This disclosure relates to gaming systems and, more particularly, to fantasy sports league gaming systems.

### BACKGROUND

Fantasy sports leagues are multi-party games that allow participants to act as fantasy team owners and build fantasy sports teams that compete against the fantasy sports teams owned by other fantasy team owners, wherein the winner of such competitions is determined based upon the performance of the real players that are included on the fantasy sports teams of the fantasy team owners. Often, the performance of the real player is defined via a point system that assigns a point value to various actions that were accomplished by the real player (e.g., completed touchdowns, completed passes, fumbles and interceptions). The popularity of such fantasy sports leagues is based, at least in part, upon the human component of the fantasy sports league. Accordingly, the winner of a particular fantasy match between two fantasy teams within a fantasy sports league may be determined based upon the actual performance of the real players included within each of the two fantasy teams.

Unfortunately, currently available lottery systems and games of chance fail to incorporate such a human component and, therefore, fail to have the excitement and unpredictability of the fantasy sports play.

### SUMMARY OF DISCLOSURE

In one implementation, a computer-implemented method of facilitating a side bet includes defining a side bet between a first participant having made a first selection in a lottery game and a second participant having made a second selection in the lottery game, wherein the side bet has a bet value. The first selection is compared to the second selection to identify a winner of the side bet and a loser of the side bet. The bet value is obtained from the loser of the side bet. At least a portion of the bet value is provided to the winner of the side bet.

One or more of the following features may be included. Providing at least a portion of the bet value to the winner of the side bet may include providing a first portion of the bet value to the winner of the side bet, and providing a second portion of the bet value to the lottery game. Comparing the first selection to the second selection may include comparing a first point value associated with the first selection to a second point value associated with the second selection to identify the winner of the side bet and the loser of the side bet.

The lottery game may be a sports-themed lottery game. The first point value associated with the first selection may be based, at least in part, upon the performance of a first group of players within a sports league. The second point value associated with the second selection may be based, at least in part, upon the performance of a second group of players within the sports league.

The lottery game may be a numbers-based lottery game. The first point value associated with the first selection may be based, at least in part, upon the difference between the first selection and a winning selection. The second point value associated with the second selection may be based, at least in part, upon the difference between the second selection and the winning selection.

In another implementation, a computer program product resides on a computer readable medium and has a plurality of instructions stored on it. When executed by a processor, the instructions cause the processor to perform operations including defining a side bet between a first participant having made a first selection in a lottery game and a second participant having made a second selection in the lottery game, wherein the side bet has a bet value. The first selection is compared to the second selection to identify a winner of the side bet and a loser of the side bet. The bet value is obtained from the loser of the side bet. At least a portion of the bet value is provided to the winner of the side bet.

One or more of the following features may be included. Providing at least a portion of the bet value to the winner of the side bet may include providing a first portion of the bet value to the winner of the side bet, and providing a second portion of the bet value to the lottery game. Comparing the first selection to the second selection may include comparing a first point value associated with the first selection to a second point value associated with the second selection to identify the winner of the side bet and the loser of the side bet.

The lottery game may be a sports-themed lottery game. The first point value associated with the first selection may be based, at least in part, upon the performance of a first group of players within a sports league. The second point value associated with the second selection may be based, at least in part, upon the performance of a second group of players within the sports league.

The lottery game may be a numbers-based lottery game. The first point value associated with the first selection may be based, at least in part, upon the difference between the first selection and a winning selection. The second point value associated with the second selection may be based, at least in part, upon the difference between the second selection and the winning selection.

In another implementation, a computing system including a processor and memory is configured to perform operations including defining a side bet between a first participant having made a first selection in a lottery game and a second participant having made a second selection in the lottery game, wherein the side bet has a bet value. The first selection is compared to the second selection to identify a winner of the side bet and a loser of the side bet. The bet value is obtained from the loser of the side bet. At least a portion of the bet value is provided to the winner of the side bet.

One or more of the following features may be included. Providing at least a portion of the bet value to the winner of the side bet may include providing a first portion of the bet value to the winner of the side bet, and providing a second portion of the bet value to the lottery game. Comparing the first selection to the second selection may include comparing a first point value associated with the first selection to a second point value associated with the second selection to identify the winner of the side bet and the loser of the side bet.

The lottery game may be a sports-themed lottery game. The first point value associated with the first selection may be based, at least in part, upon the performance of a first group of players within a sports league. The second point value associated with the second selection may be based, at least in part, upon the performance of a second group of players within the sports league.

The lottery game may be a numbers-based lottery game. The first point value associated with the first selection may be based, at least in part, upon the difference between the first selection and a winning selection. The second point value associated with the second selection may be based, at least in part, upon the difference between the second selection and the winning selection.

The details of one or more implementations are set forth in the accompanying drawings and the description below. Other features and advantages will become apparent from the description, the drawings, and the claims.

### BRIEF DESCRIPTION OF THE DRAWINGS

FIG. 1 is a diagrammatic view of a distributed computing network including a computing device that executes a gaming process according to an implementation of the present disclosure;

FIG. 2 is a flowchart of a first implementation of the gaming process of FIG. 1 according to an implementation of the present disclosure;

FIG. 3 is a diagrammatic view of the process of defining a fantasy football team;

FIG. 4 is a flowchart of a second implementation of the gaming process of FIG. 1 according to an implementation of the present disclosure; and

FIG. 5 is a flowchart of a third implementation of the gaming process of FIG. 1 according to an implementation of the present disclosure.

Like reference symbols in the various drawings indicate like elements.

### DETAILED DESCRIPTION OF THE PREFERRED EMBODIMENTS

System Overview

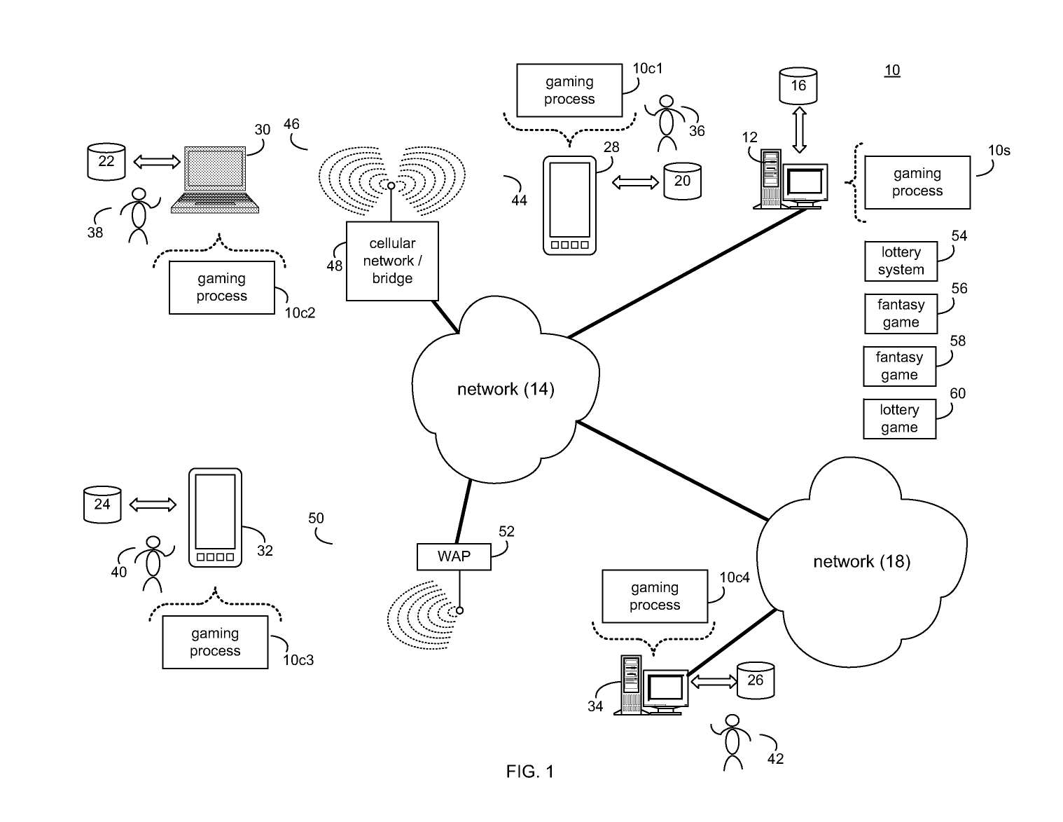

In FIG. 1, there is shown gaming process 10. Gaming process 10 may be implemented as a server-side process, a client-side process, or a hybrid server-side/client-side process. For example, gaming process 10 may be implemented as a purely server-side process via gaming process 10s. Alternatively, gaming process 10 may be implemented as a purely client-side process via one or more of gaming process 10c1, gaming process 10c2, gaming process 10c3, and gaming process 10c4. Alternatively still, gaming process 10 may be implemented as a hybrid server-side/client-side process via gaming process 10s in combination with one or more of gaming process 10c1, gaming process 10c2, gaming process 10c3, and gaming process 10c4. Accordingly, gaming process 10 as used in this disclosure may include any combination of gaming process 10s, gaming process 10c1, gaming process 10c2, gaming process 10c3, and gaming process 10c4.

Gaming process 10s may be a server application and may reside on and may be executed by computing device 12, which may be connected to network 14 (e.g., the Internet or a local area network). Examples of computing device 12 may include, but are not limited to: a personal computer, a laptop computer, a personal digital assistant, a data-enabled cellular telephone, a notebook computer, a television with one or more processors embedded therein or coupled thereto, a server computer, a series of server computers, a mini computer, a mainframe computer, or a dedicated network device.

The instruction sets and subroutines of gaming process 10s, which may be stored on storage device 16 coupled to computing device 12, may be executed by one or more processors (not shown) and one or more memory architectures (not shown) included within computing device 12. Examples of storage device 16 may include but are not limited to: a hard disk drive; a tape drive; an optical drive; a RAID device; a random access memory (RAM); a read-only memory (ROM); and all forms of flash memory storage devices.

Network 14 may be connected to one or more secondary networks (e.g., network 18), examples of which may include but are not limited to: a local area network; a wide area network; or an intranet, for example.

Examples of gaming processes 10c1, 10c2, 10c3, 10c4 may include but are not limited to a web browser, a web browser plug-in or applet, a game console user interface, a video conference user interface, or a specialized application (e.g., an application running on e.g., the Android™ platform or the iOS™ platform). The instruction sets and subroutines of gaming processes 10c1, 10c2, 10c3, 10c4, which may be stored on storage devices 20, 22, 24, 26 (respectively) coupled to client electronic devices 28, 30, 32, 34 (respectively), may be executed by one or more processors (not shown) and one or more memory architectures (not shown) incorporated into client electronic devices 28, 30, 32, 34 (respectively). Examples of storage devices 20, 22, 24, 26 may include but are not limited to: hard disk drives; tape drives; optical drives; RAID devices; random access memories (RAM); read-only memories (ROM), and all forms of flash memory storage devices.

Examples of client electronic devices 28, 30, 32, 34 may include, but are not limited to, data-enabled, cellular telephone 28, laptop computer 30, personal digital assistant 32, personal computer 34, a notebook computer (not shown), a server computer (not shown), a gaming console (not shown), a television (not shown), a tablet computer (not shown) and a dedicated network device (not shown). Client electronic devices 28, 30, 32, 34 may each execute an operating system, examples of which may include but are not limited to Microsoft Windows™, Android™, WebOS™, iOS™, Redhat Linux™, or a custom operating system.

The various client electronic devices (e.g., client electronic devices 28, 30, 32, 34) may be directly or indirectly coupled to network 14 (or network 18). For example, data-enabled, cellular telephone 28 and laptop computer 30 are shown wirelessly coupled to network 14 via wireless communication channels 44, 46 (respectively) established between data-enabled, cellular telephone 28, laptop computer 30 (respectively) and cellular network/bridge 48, which is shown directly coupled to network 14. Further, personal digital assistant 32 is shown wirelessly coupled to network 14 via wireless communication channel 50 established between personal digital assistant 32 and wireless access point (i.e., WAP) 52, which is shown directly coupled to network 14. Additionally, personal computer 34 is shown directly coupled to network 18 via a hardwired network connection.

WAP 52 may be, for example, an IEEE 802.11a, 802.11b, 802.11g, 802.11n, Wi-Fi, and/or Bluetooth device that is capable of establishing wireless communication channel 50 between personal digital assistant 32 and WAP 52. As is known in the art, IEEE 802.11x specifications may use Ethernet protocol and carrier sense multiple access with collision avoidance (i.e., CSMA/CA) for path sharing. The various 802.11x specifications may use phase-shift keying (i.e., PSK) modulation or complementary code keying (i.e., CCK) modulation, for example. As is known in the art, Bluetooth is a telecommunications industry specification that allows e.g., mobile phones, computers, and personal digital assistants to be interconnected using a short-range wireless connection.

As discussed above, fantasy sports leagues are multi-party games that allow participants to act as fantasy team owners and build fantasy sports teams that compete against the fantasy sports teams owned by other fantasy team owners, wherein the winner of such competitions is determined based upon the performance of the real players that are included on the fantasy sports teams of the fantasy team owners.

The popularity of such fantasy sports league is based, at least in part, upon the human component of the fantasy sports league. Accordingly, the winner of a particular fantasy match between two fantasy teams within a fantasy sports league may be determined based upon the actual performance of the real players included within each of the two fantasy teams.

Gaming process 10 may be configured to replicate the excitement of such a fantasy sports league within a lottery system. Assume for illustrative purposes that users 36, 38, 40, 42 are players of lottery system 54. Further assume that gaming process 10 is configured to offer specific games via lottery system 54.

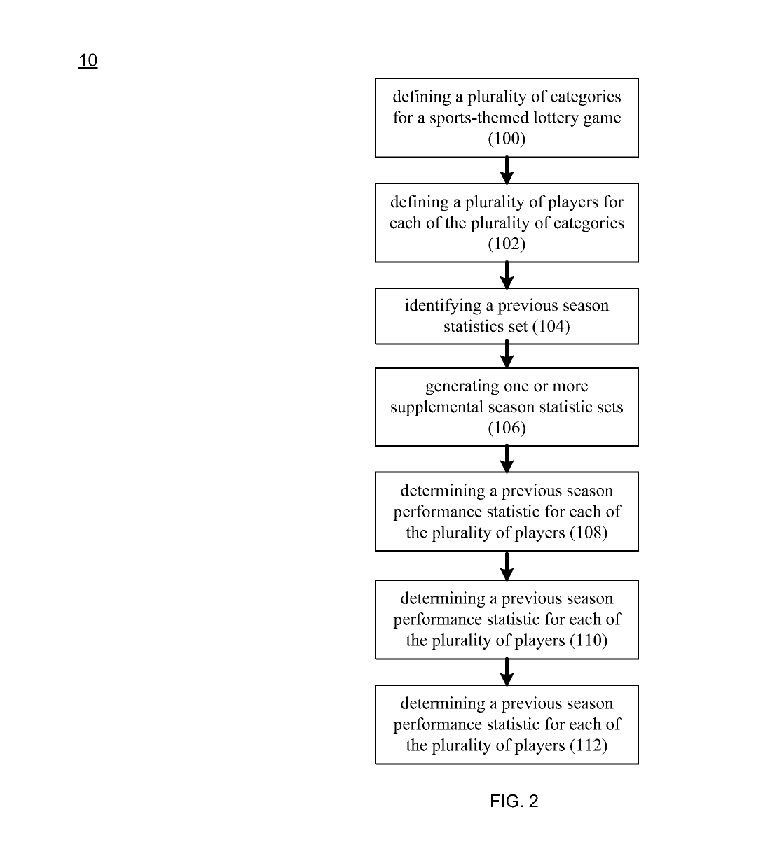

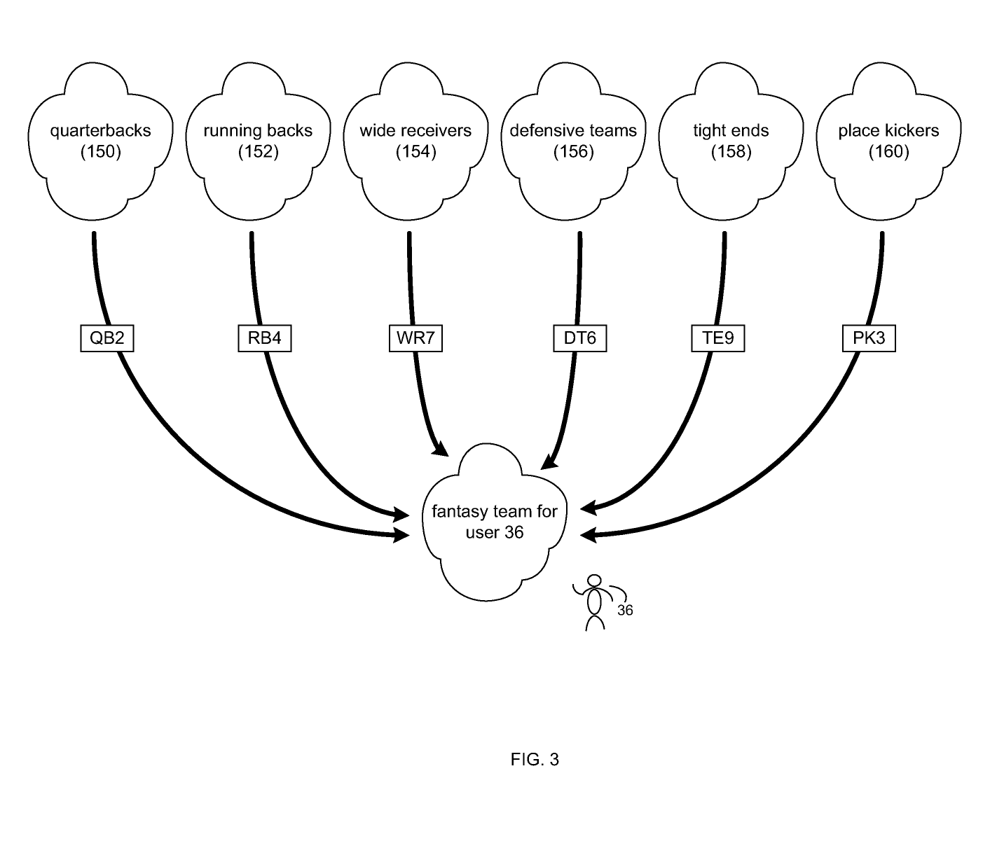

Specifically and referring also to FIGS. 2-3, gaming process 10 may be configured to offer (within lottery system 54) a sport-themed lottery game based upon a fantasy sports league. For illustrative purposes, assume that gaming process 10 is configured to offer a football sports-themed lottery game (e.g., fantasy game 56) that may allow e.g., users 36, 38, 40, 42 to participate in a fantasy football league. While in this particular example, fantasy game 56 is described as being a fantasy football lottery game, this is for illustrative purposes only and is not intended to be a limitation of this disclosure, as other configurations are possible and are considered to be within the scope of this disclosure. For example, fantasy game 56 may alternatively be e.g., a fantasy basketball lottery game, a fantasy baseball lottery game, or a fantasy hockey lottery game.

Gaming process 10 may define 100 a plurality of categories (e.g., categories 150, 152, 154, 156, 158, 160) for a sports-themed lottery game (e.g., fantasy game 56), wherein this plurality of categories (e.g., categories 150, 152, 154, 156, 158, 160) may define a plurality of positions within a sports team. As discussed above, since (in this example) fantasy game 56 offered by gaming process 10 is a football sports-themed lottery game, the plurality of categories (e.g., categories 150, 152, 154, 156, 158, 160) defined 100 by gaming process 10 may represent a plurality of positions within a football team. Examples of such positions may include but are not limited to quarterbacks, running backs, wide receivers, defensive team, tight end, and place kicker

The quantity of categories defined 100 by gaming process 10 may vary depending upon the anticipated playing region of fantasy game 56. Specifically, the larger the region and the greater the number of anticipated players for fantasy game 56, the greater the number of categories required to make fantasy game 56 competitive. Conversely, the smaller the region and the lower the number of anticipated players for fantasy game 56, the lesser the number of categories required to make fantasy game 56 competitive. For example, if fantasy game 56 is offered with too few categories, the odds of a participant winning fantasy game 56 may be driven too high (resulting in too many wins) and the prize for winning fantasy game 56 may not be permitted to build to a high enough level to entice people to play fantasy game 56. Conversely, if fantasy game 56 is offered with too many categories, the odds of a participant winning fantasy game 56 may be driven too low (resulting in too few wins) and the prize may not be won for a long period of time, resulting in a lower level of interest in fantasy game 56.

Assume for illustrative purposes that gaming process 10 defined six categories for fantasy game 56, namely quarterback category 150, running back category 152, wide receiver category 154, defensive team category 156, tight end category 158, and place kicker category 160. Accordingly, when a player (e.g., users 36, 38, 40, 42) of fantasy game 56 defines their fantasy team, they may select one quarterback (from quarterback category 150), one running back (from running back category 152), one wide receiver (from wide receiver category 154), one defensive team (from defensive team category 156), one tight end (from tight end category 158), and one place kicker (from place kicker category 160) for inclusion within their fantasy football team.

Gaming process 10 may define 102 a plurality of players for each of the plurality of categories (e.g., categories 150, 152, 154, 156, 158, 160). For example, included within quarterback category 150 may be one quarterback from each NFL team; included within running back category 152 may be one running back from each NFL team; included within wide receiver category 154 may be one wide receiver from each NFL team; included within defensive team category 156 may be one defensive team from each NFL team; included within tight end category 158 may be one tight end from each NFL team; and included within place kicker category 160 may be one place kicker from each NFL team.

For illustrative purposes, assume that user 36 defined their fantasy team (e.g., fantasy team 162) to include: Quarterback QB2 (chosen from quarterback category 150), Running Back RB4 (chosen from running back category 152), Wide Receiver WR7 (chosen from wide receiver category 154), Defensive Team DT6 (chosen from defensive team category 156), Tight End TE9 (chosen from tight end category 158), and Place Kicker PK3 (chosen from place kicker category 160).

As is known in the art, during a fantasy football season, the individual players included within the league (e.g., all of the quarterbacks, running backs, wide receivers, defensive teams, tight ends, and place kickers) may be assigned a point score based upon their performance during e.g., a particular week, wherein the actual point score is calculated based upon a set of point rules.

An example of such a set of point rules may be as follows:

### For Quarterbacks, Running Backs, Wide Receivers and Tight Ends

6 pts per rushing or receiving TD
6 pts for player returning kick/punt for TD
6 pts for player returning or recovering a fumble for TD
4 pts per passing TD
2 pts per rushing or receiving 2 pt conversion
2 pts per passing 2 pt conversion
1 pt per 10 yards rushing or receiving
1 pt per 25 yards passing

### For Piece Kickers

5 pts per 50+ yard FG made
4 pts per 40-49 yard FG made
3 pts per FG made, 39 yards or less
2 pts per rushing, passing, or receiving 2 pt conversion
1 pt per Extra Point made

### For Defensive Teams

10 pts for 0 points allowed
7 pts for 2-6 points allowed
4 pts for 7-13 points allowed
1 pt for 14-17 points allowed
0 pts for 18-21 points allowed
−1 pt for 22-27 points allowed
−4 pts for 28-34 points allowed
−7 pts for 35-45 points allowed
−10 pts for 46+ points allowed

Accordingly, game process 10 may calculate a point score for each player included in each of categories 150, 152, 154, 156, 158, 160 to rate their performance during a defined period of time (e.g., the previous week), wherein the player having the highest score within their category wins that category. For example, the quarterback having the highest point score within quarterback category 150 for a particular week may be defined as the winning quarterback for that week.

Accordingly, at the end of any given week during the NFL season, one quarterback, one running back, one wide receiver, one defensive team, one tight end, and one place kicker may be defined by gaming process 10 as the winners of their respective categories for that week. Accordingly, if a user happened to pick correctly each of these categories, that user may be defined by gaming process 10 as the winner of e.g., fantasy game 56 for the week in question.

Continuing with the above-stated example, if Quarterback QB2, Running Back RB4, Wide Receiver WR7, Defensive Team DT6, Tight End TE9, and Place Kicker PK3 were defined by gaming process 10 as the winners of their respective categories during a week in which user 36 selected these six players for inclusion within their fantasy team, user 36 would be defined by game process 10 as the winner of fantasy game 56 for that week. Conversely, in the event that no one selected the correct six players for inclusion within their fantasy team, gaming process 10 may determine that no one won fantasy game 56 and the prize may continue to grow until e.g., the end of the next week when a new set of winners may be defined by gaming process 10 for each category. Accordingly, if a user selected those six players for inclusion within their fantasy team, that user would be defined by game process 10 as the winner of fantasy game 56 for that week

Unfortunately, the length of a season for a particular sport may be short (e.g., sixteen regular season games for the NFL). Further, the length of the career of an athlete may also be short, especially in sports that are prone to injury (such as the NFL). Accordingly, it may be difficult for a lottery system (e.g., lottery system 54) that is based upon a fantasy sports league to determine the odds of a particular player winning a particular category for a given week. Specifically, while some quarterbacks have better records than other quarterbacks during any given football season; was that better performance due to their superior performance on the playing field . . . or simply the subpar performance of their competition on the playing field. While statistically this question would be answered over the course of a much longer playing season and/or a much longer playing career, such information is typically not available due to shorter playing seasons and/or playing careers.

Accordingly, gaming process 10 may be configured to process the data of a previous playing season to produce a much larger quantity of supplemental (and fictitious) playing seasons to provide a higher level of insight into the anticipated performance of a particular player. For the purpose of providing an easy to follow example, assume that quarterback category 150 includes only six quarterbacks, namely Quarterbacks A, B, C, D, E and F. Further, assume that the previous playing season is only four weeks long and includes only four games, namely Games 1, 2, 3 and 4. While the following discussion concerns only one category (namely quarterback category 150), it is understood that the following discussion is equally applicable to all categories included within fantasy game 56.

Quarterbacks (Category 150)

| | 1 | 2 | 3 | 4 |
|---|---|---|---|---|
| A | 16 | 5 | 17 | 28 |
| B | 18 | 2 | 26 | 9 |
| C | 3 | 52 | 51 | 8 |
| D | 23 | 16 | 22 | 29 |
| E | 19 | 33 | 6 | 30 |
| F | 26 | 14 | 47 | 16 |
| | F | C | C | E |

From the above table, it is clear that Quarterback F won Week 1 (with a point score of 26); Quarterback C won Week 2 (with a point score of 52); Quarterback C won Week 3 (with a point score of 51); and Quarterback E won Week 4 (with a point score of 30). Accordingly, Quarterbacks A, B & D did not win any weeks.

Generating Supplemental Seasons

As discussed above, gaming process 10 may be configured to process the data of a previous playing season to produce a much larger quantity of supplemental (and fictitious) playing seasons to provide a higher level of insight into the anticipated performance of a particular player. Accordingly, assume for illustrative purposes that gaming process 10 processes the above-described seasonal data to produce five additional sets of fantasy seasonal data, thus expanding the data available for one season to six seasons (i.e., one real season plus five fantasy seasons). Again and as discussed above, while the following discussion concerns only one category (namely quarterback category 150), it is understood that the following discussion is equally applicable to all categories included within fantasy game 56.

Continuing with the above-stated example, gaming process 10 may identify 104 a previous season statistics set (e.g., the above-described seasonal data), wherein the previous season statistics set includes a player performance statistics set for each of the plurality of players, each player performance statistics set including a plurality of per-game performance indicators. This previous season statistics set may define the performance of each of the plurality of players (e.g., Quarterbacks A-F) during the previous season. Further, each of the plurality of per-game performance indicators may define the performance of one of the plurality of players during a particular game included within the previous season.

As shown in the above table, six quarterbacks are defined (namely A, B, C, D, E and F), wherein this table shows the manner in which these six quarterbacks performed over the course of the four weeks (and four games) of the previous season. Accordingly, the player performance statistic set for Quarterback A is 16, 5, 17, 28, wherein: 16 is the per-game performance indicator (e.g., point score) assigned to Quarterback A for their performance is Game 1; 5 is the per-game performance indicator (e.g., point score) assigned to Quarterback A for their performance is Game 2; 17 is the per-game performance indicator (e.g., point score) assigned to Quarterback A for their performance is Game 3; and 28 is the per-game performance indicator (e.g., point score) assigned to Quarterback A for their performance is Game 4. Similar information may be extracted from the above-table with respect to Quarterbacks B-F.

Continuing with the above-stated example in which gaming process 10 processes the above-described seasonal data (e.g., the previous season statistics set) to produce five additional sets of fantasy seasonal data, gaming process 10 may generate 106 one or more supplemental season statistic sets by rearranging at least two of the per-game performance indicators included within the previous season statistics set (e.g., the above-described seasonal data).

While the following discussion concerns gaming process 10 generating five additional sets of fantasy seasonal data, this is for illustrative purposes only, as the actual number of sets of fantasy seasonal data generated will often be much higher (e.g., in the 10,000 to 100,000 range). Further and as discussed above, these sets of fantasy seasonal data may concern players included within all categories (e.g., categories 150, 152, 154, 156, 158, 160), as opposed to only those players included within quarterback category 150.

Accordingly, gaming process 10 may generate 106 a first supplemental season statistics set (e.g., Fantasy Season #1) as follows:

Quarterbacks (Category 150)

| | 1 | 2 | 3 | 4 |
|---|---|---|---|---|
| A | 17 | 5 | 28 | 16 |
| B | 9 | 2 | 18 | 26 |
| C | 8 | 52 | 51 | 3 |
| D | 16 | 29 | 22 | 23 |
| E | 6 | 33 | 19 | 30 |
| F | 14 | 26 | 16 | 47 |
| | A | C | C | F |

In the first supplemental season statistics set (e.g., Fantasy Season #1), gaming process 10 generated 106 Fantasy Season #1 by rearranging the per-game performance indicators included within the previous season statistics set (e.g., the above-described seasonal data) in an essentially random fashion.

From the above table, it is clear that in Fantasy Season #1, Quarterback A won Week 1 (with a point score of 17); Quarterback C won Week 2 (with a point score of 52); Quarterback C won Week 3 (with a point score of 51); and Quarterback F won Week 4 (with a point score of 47). Accordingly, Quarterbacks B, D & E did not win any weeks.

Gaming process 10 may generate 106 a second supplemental season statistics set (e.g., Fantasy Season #2) as follows:

Quarterbacks (Category 150)

| | 1 | 2 | 3 | 4 |
|---|---|---|---|---|
| A | 28 | 16 | 5 | 17 |
| B | 26 | 9 | 18 | 2 |
| C | 8 | 3 | 52 | 51 |
| D | 16 | 22 | 29 | 23 |
| E | 19 | 33 | 6 | 30 |
| F | 26 | 14 | 47 | 16 |
| | A | E | C | C |

In the second supplemental season statistics set (e.g., Fantasy Season #2), gaming process 10 generated 106 Fantasy Season #2 by rearranging the per-game performance indicators included within the previous season statistics set (e.g., the above-described seasonal data) in an essentially random fashion.

From the above table, it is clear that in Fantasy Season #2, Quarterback A won Week 1 (with a point score of 28); Quarterback E won Week 2 (with a point score of 33); Quarterback C won Week 3 (with a point score of 52); and Quarterback C won Week 4 (with a point score of 51). Accordingly, Quarterbacks B, D & F did not win any weeks.

Gaming process 10 may generate 106 a third supplemental season statistics set (e.g., Fantasy Season #3) as follows:

Quarterbacks (Category 150)

| | 1 | 2 | 3 | 4 |
|---|---|---|---|---|
| A | 5 | 17 | 28 | 16 |
| B | 9 | 18 | 2 | 26 |
| C | 3 | 52 | 51 | 8 |
| D | 29 | 23 | 16 | 22 |
| E | 19 | 33 | 6 | 30 |
| F | 14 | 47 | 16 | 26 |
| | D | C | C | E |

In the third supplemental season statistics set (e.g., Fantasy Season #3), gaming process 10 generated 106 Fantasy Season #3 by rearranging the per-game performance indicators included within the previous season statistics set (e.g., the above-described seasonal data) in an essentially random fashion.

From the above table, it is clear that in Fantasy Season #3, Quarterback D won Week 1 (with a point score of 29); Quarterback C won Week 2 (with a point score of 52); Quarterback C won Week 3 (with a point score of 51); and Quarterback E won Week 4 (with a point score of 30). Accordingly, Quarterbacks A, B & F did not win any weeks.

Gaming process 10 may generate 106 a fourth supplemental season statistics set (e.g., Fantasy Season #4) as follows:

Quarterbacks (Category 150)

| | 1 | 2 | 3 | 4 |
|---|---|---|---|---|
| A | 17 | 28 | 5 | 16 |
| B | 9 | 26 | 18 | 2 |
| C | 52 | 3 | 51 | 8 |
| D | 23 | 29 | 22 | 16 |
| E | 6 | 30 | 33 | 19 |
| F | 26 | 47 | 14 | 16 |
| | C | E | C | E |

In the fourth supplemental season statistics set (e.g., Fantasy Season #4), gaming process 10 generated 106 Fantasy Season #4 by rearranging the per-game performance indicators included within the previous season statistics set (e.g., the above-described seasonal data) in an essentially random fashion.

From the above table, it is clear that in Fantasy Season #4, Quarterback C won Week 1 (with a point score of 52); Quarterback E won Week 2 (with a point score of 30); Quarterback C won Week 3 (with a point score of 51); and Quarterback E won Week 4 (with a point score of 19). Accordingly, Quarterbacks A, B, D & F did not win any weeks.

Gaming process 10 may generate 106 a fifth supplemental season statistics set (e.g., Fantasy Season #5) as follows:

Quarterbacks (Category 150)

| | 1 | 2 | 3 | 4 |
|---|---|---|---|---|
| A | 28 | 17 | 16 | 5 |
| B | 18 | 26 | 29 | 2 |
| C | 51 | 8 | 3 | 52 |
| D | 29 | 23 | 16 | 22 |
| E | 33 | 6 | 30 | 19 |
| F | 16 | 47 | 26 | 14 |
| | C | F | E | C |

In the fifth supplemental season statistics set (e.g., Fantasy Season #5), gaming process 10 generated 106 Fantasy Season #5 by rearranging the per-game performance indicators included within the previous season statistics set (e.g., the above-described seasonal data) in an essentially random fashion.

From the above table, it is clear that in Fantasy Season #5, Quarterback C won Week 1 (with a point score of 51); Quarterback F won Week 2 (with a point score of 47); Quarterback E won Week 3 (with a point score of 30); and Quarterback C won Week 4 (with a point score of 52). Accordingly, Quarterbacks A, B & D did not win any weeks.

Through the use of the five above-described supplemental season statistics sets, gaming system 10 may determine a higher level of insight into the anticipated performance of a particular player (e.g., Quarterback A).

For example, gaming process 10 may determine 108 a previous season performance statistic for each of the plurality of players based, at least in part, upon the plurality of per-game performance indicators included within the previous season statistics set (e.g., the above-described seasonal data). Since Quarterback A did not win a single week in the previous season statistics set, the previous season performance statistic for Quarterback A is 0%.

Additionally, gaming process 10 may determine 110 one or more supplemental season performance statistics for each of the plurality of players based, at least in part, upon a plurality of per-game performance indicators included within each of the one or more supplemental season statistics sets (e.g., Fantasy Season #1-Fantasy Season #5).

Since Quarterback A won Week #1 in Fantasy Season #1, the supplemental season performance statistic for Fantasy Season #1 for Quarterback A is 25%. Since Quarterback A won Week #1 in Fantasy Season #2, the supplemental season performance statistic for Fantasy Season #2 for Quarterback A is 25%. Since Quarterback A did not win any weeks in Fantasy Season #3, the supplemental season performance statistic for Fantasy Season #3 for Quarterback A is 0%. Since Quarterback A did not win any weeks in Fantasy Season #4, the supplemental season performance statistic for Fantasy Season #4 for Quarterback A is 0%. Since Quarterback A did not win any weeks in Fantasy Season #5, the supplemental season performance statistic for Fantasy Season #5 for Quarterback A is 0%.

Once the above-described supplemental season performance statistics are determined 110 by gaming process 10, gaming process 10 may generate 112 an expanded performance statistic for each of the plurality of players based, at least in part, upon the previous season performance statistic (i.e., 0%) of each of the plurality of players and the one or more supplemental season performance statistics (i.e., 25%, 25%, 0%, 0% 0%) of each of the plurality of players. In this particular example, gaming process 10 may generate 112 an expanded performance statistic of 8.33% for Quarterback A when taking into account his performance in the previous season and the five fantasy seasons.

Accordingly and through the use of the five fantasy seasons, it seems that Quarterback A is actually better than the data produced by the single previous season would indicate. As discussed above and for the purposes of simplicity, the above example only described the manner in which the performance of one player (Quarterback A) within one category (Quarterback category 150) could be analyzed by generating five fantasy seasons. However, gaming process 10 would typically analyze the performance of all players (e.g., 16+ players) within all categories (e.g., 6+ categories) through the use of considerably more fantasy seasons (e.g., 10,000-100,000).

Once the above-described expanded performance statistics are generated 112 by gaming process 10, gaming process 10 may utilize such expanded performance statistics for various purposes, examples of which include but are not limited to: setting the odds associated with each player winning a particular week and setting the prize values associated with a winning ticket. For example, since one quarterback may be more likely to win a particular week than another quarterback, the odds associated with the better quarterback winning may be lower than the odds associated with the other quarterback winning (e.g., to entice participants to select the lesser performing quarterback through the use of a higher odds multiplier). And as is known in the art, these odds may be used to adjust the prize amount paid out in response to a winning ticket (e.g., matching six out of six picks . . . or five out of six picks).

Gaming process 10 was described above as generating 106 Fantasy Seasons 1-5 by rearranging per-game performance indicators included within the previous season statistics set (e.g., the above-described seasonal data). Specifically, the performances of the individual quarterbacks were rearranged individually to form new pairings without maintaining the original pairing. However, this description is merely for illustrative purposes only and is not intended to be a limitation of this disclosure, as other configurations are possible. For example, gaming process 10 may generate 106 the Fantasy Seasons by rearranging per-game performance indicators included within the previous season statistics set (e.g., the above-described seasonal data) while maintaining the original pairings. Final Fours

While gaming process 10 is generically described above as e.g., allowing a user to pick one player from each of six categories, resulting in the generation of a fantasy football team for the user, wherein the success of the user's picks are determined by seeing how many of the user's six picks received the highest point score in their respective categories, this is for illustrative purposes only.

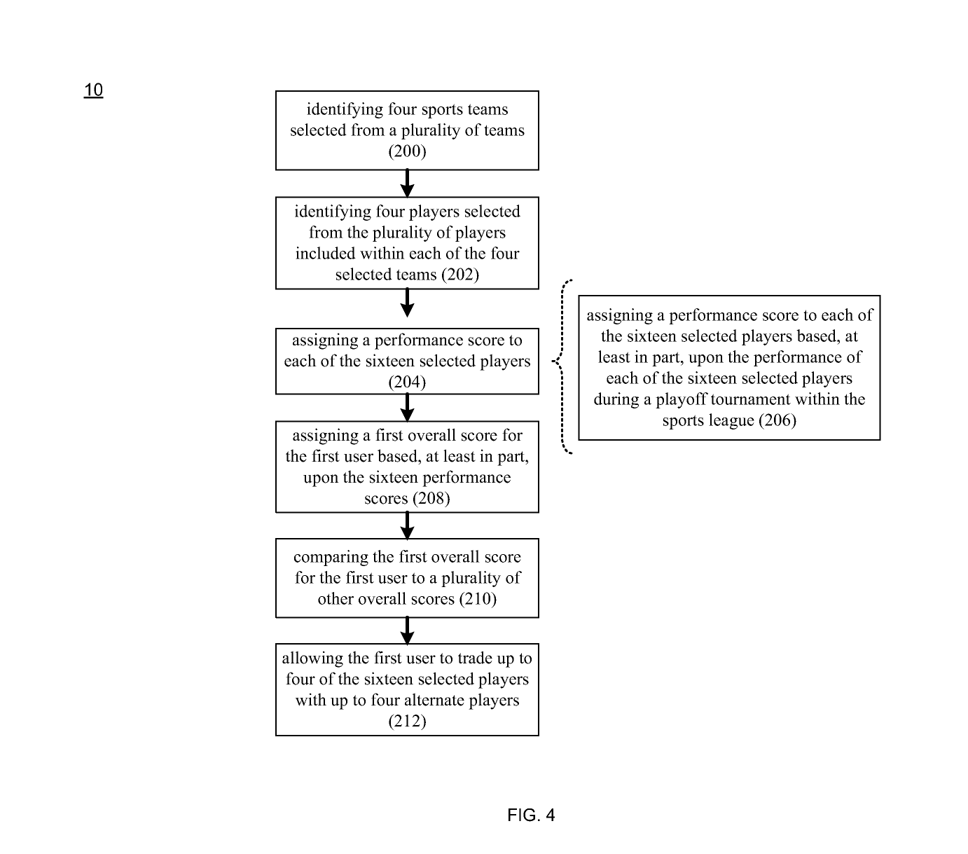

Referring also to FIG. 4, gaming process 10 may be configured to administer and execute other types of games (e.g., fantasy game 58). For example, gaming process 10 may be configured to execute a game that allows users to select basketball teams that they believe will compete in a Final Four series.

While the following example concerns a basketball tournament, this is for illustrative purposes only and is not intended to be a limitation of this disclosure. Specifically, the following discussion is equally applicable to any sporting tournament in which teams are subsequently eliminated until the final two teams play each other, examples of which may include but are not limited to postseason baseball, postseason football and postseason hockey.

Specifically, gaming process 10 may be configured to allow a user to identify 200 four sports teams (selected from a plurality of teams included within a sports league), thus defining four teams selected teams for a first user (e.g., user 36). An example of these four teams may be four teams within an NBA or NCAA league.

Gaming process 10 may be configured to also allow a user (e.g., user 36) to identify 202 four players (selected from the plurality of players) included within each of the four selected teams, thus defining sixteen selected players for the user (e.g., user 36). Accordingly, gaming process 10 may be configured to allow user 36 to identify 200 the four basketball teams that they believe will be in e.g., the NCAA Final Four tournament. Further, gaming process 10 may be configured to allow user 36 to identify 202 four players from each of the four teams identified 200 by user 36. When identifying 202 the four players from each team, the user may select these four players based upon their belief concerning which players would achieve the highest point score (in the manner discussed above), wherein points are given to individual players based upon their performance during a game (e.g., following a standardized fantasy sports scoring systems, such as rotisserie, point-based, and head-to-head).

As the tournament proceeds, gaming process 10 may assign 204 a performance score to each of the sixteen selected players (i.e., the four players that were identified 202 for each of the four teams identified 200), thus defining sixteen performance scores for user 36. As discussed above, when assigning 204 a performance score to each of the sixteen players identified 202, gaming process 10 may assign 206 a performance score to each of the sixteen selected players based, at least in part, upon the performance of each of the sixteen selected players during the playoff tournament (e.g., the NCAA Final Four) within the sports league (e.g., NCAA Basketball).

Once the tournament has been completed, gaming process 10 may assign 208 an overall score for user 36 based, at least in part, upon the sixteen performance scores described above. For example and upon completion of the NCAA Final Four, gaming process 10 may simple determine a sum of the point scores assigned 206 to each of the sixteen players (identified 202 by user 36) during the Final Four tournament, wherein this sum represents the total score for user 36.

When determining an overall winner for fantasy game 58, gaming process 10 may compare 210 the overall score for user 36 to a plurality of other overall scores for a plurality of other users (e.g., for users 38, 40, 42) to define a winner. For example, in the event that user 36 has the highest overall score (amongst all of the other players of fantasy game 58), gaming process 10 may determine that user 36 is the winner of fantasy game 58 and user 36 may be provided with the appropriate winnings (which, as discussed above, may be based upon odds derived by gaming process 10 through the use of a plurality of fantasy seasons).

Additionally, gaming process 10 may be configured to allow 212 a user (e.g., user 36) to trade up to four of the sixteen selected players with up to four alternate players, wherein two or more of these four alternate players may be from a single team within the sports league or from different teams within the sports league.

For example, in the event that one of the player identified 202 by user 36 becomes injured on each of the four teams identified 200 by user 36, gaming process 10 may allow 212 user 36 to trade a single player on each of the four teams identified 200 with a non-injured player from the same team, resulting in a total of four trades. Alternatively, in the event that one of the teams identified 200 by user 36 does not make it to the Final Four, gaming process 10 may allow user 36 to trade all four player of the team for four players from another team (essentially swapping out the team that did not make it to the Final Four).

Side Bet System

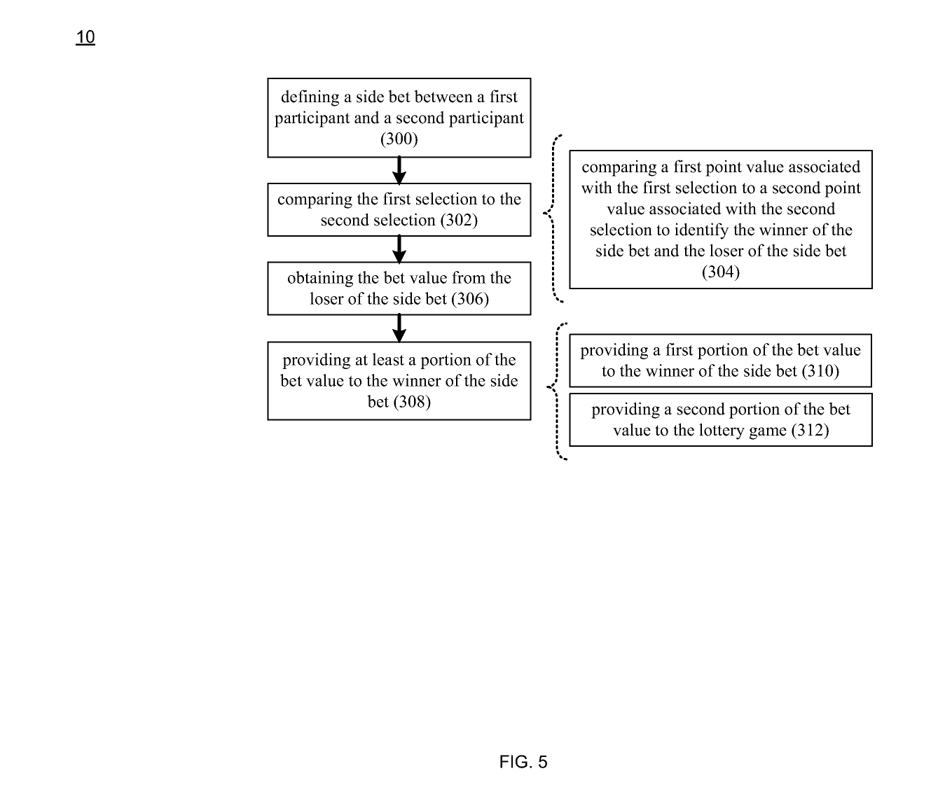

Gaming system 10 may further be configured to allow one or more users of gaming system 10 to make side bets with each other user. Referring also to FIG. 5, gaming process 10 may define 300 a side bet between a first participant (e.g., user 36) having made a first selection (e.g., chosen a first fantasy football team) in a lottery game (e.g., fantasy game 56) and a second participant (e.g., user 38) having made a second selection (e.g., chosen a second fantasy football team) in the lottery game (e.g., fantasy game 56). When defining 300 a side bet between users 36, 38, a bet value may be defined for the side bet.

As discussed above, assume that user 36 defined their fantasy team to include: Quarterback QB2, Running Back RB4, Wide Receiver WR7, Defensive Team DT6, Tight End TE9, and Place Kicker PK3. Further assume that user 38 defined their fantasy team to include: Quarterback QB1, Running Back RB3, Wide Receiver WR2, Defensive Team DT9, Tight End TE1, and Place Kicker PK6.

Accordingly, assume for illustrative purposes that user 36 and user 38 are friends & coworkers. Further, assume that user 36 contacts user 38 (via gaming process 10) to propose that user 36 and user 38 enter into a side bet for $10 (i.e., the bet value). Accordingly and as discussed above, gaming process 10 may be configured to define 300 such a side bet for users 36, 38. Assume for illustrative purposes that both of users 36, 38 have accounts established with lottery system 54 and, therefore, users 36, 38 may fund their side bet via e.g., credit card numbers that are stored within lottery system 54.

Upon the expiry of the event associated with the side bet (e.g., week 6 of the standard NFL season), gaming process 10 may compare 302 the first selection (e.g., Quarterback QB2, Running Back RB4, Wide Receiver WR7, Defensive Team DT6, Tight End TE9, and Place Kicker PK3 of user 36) to the second selection (e.g., Quarterback QB1, Running Back RB3, Wide Receiver WR2, Defensive Team DT9, Tight End TE1, and Place Kicker PK6 of user 38) to identify a winner of the side bet and a loser of the side bet.

When comparing 302 the first selection to the second selection, gaming process 10 may compare 304 a first point value associated with the first selection to a second point value associated with the second selection to identify the winner of the side bet and the loser of the side bet. These point values for these fantasy teams may be calculated in the manner described above (e.g., based upon the actual performances of the individual players include within the fantasy teams and based upon a defined scoring system).

Accordingly, assume for illustrative purposes that the fantasy team of user 38 generated a point score of 151 points (during the sixth week of the NFL season), while the fantasy team of user 36 generated a point score of 132 points (during the sixth week of the NFL season). Accordingly and upon completing comparison 304, gaming process 10 may determine user 38 to be the winner of the side bet.

Once the winner and the loser are identified, gaming process 10 may obtain 306 the bet value from the loser (e.g., user 36) of the side bet and may provide 308 at least a portion of the bet value to the winner (e.g., user 38) of the side bet. Accordingly, $10 may be charged to the credit card of user 36 that is on file with lottery system 54. Further, a portion of this $10 may be credited to an account associated with user 38 within lottery system 54.

When providing 308 at least a portion of the bet value to the winner (e.g., user 38) of the side bet, gaming process 10 may provide 310 a first portion of the bet value (e.g., $9) to the winner of the side bet (e.g., user 38), and may provide 312 a second portion of the bet value (e.g., $1) to lottery game 54.

While gaming system 10 is described above as being configured to work with a sports-based lottery game, this is for illustrative purposes only and is not intended to be a limitation of this disclosure, as other configurations are possible and are considered to be within the scope of this disclosure. For example, the lottery game may be a numbers-based lottery game (e.g., lottery game 60), in which the people entering into the side bet (e.g., users 36, 38) select a defined quantity of numbers. An example of lottery game 60 may include a “Pick 4” type game. Accordingly, the first point value associated with the first selection (e.g., the selection of user 36) may be based, at least in part, upon the difference between the first selection and the winning selection (e.g., the actual winning number). Accordingly, the second point value associated with the second selection (e.g., the selection of user 38) may be based, at least in part, upon the difference between the second selection and the winning selection.

When determine the difference between a selection and a winning number, various techniques may be utilized, such as assigning a point value for selecting a correct number (e.g., a “4”) that is in the wrong position (e.g., in the second position as opposed to the fourth position). Additionally, points may be assigned when the number selected for a certain position is one number above or one number below the winning number in that position (e.g., a 3 versus a 2). Additionally, points may be assigned for matching combinations of number (e.g., one out of four, two out of four, three out of four). The previous examples are intended to be illustrative and not all inclusive. Accordingly, gaming process 10 may be configured to assign points using other techniques.

While the previous discussion concerns defining 300 a side bet between a first participant (e.g., user 36) having made a first selection (e.g., chosen a first fantasy football team) in a lottery game (e.g., fantasy game 56) and a second participant (e.g., user 38) having made a second selection (e.g., chosen a second fantasy football team) in the lottery game (e.g., fantasy game 56), this particular configuration is for illustrative purposes only and is not intended to be a limitation of this disclosure, as other configurations are possible. For example, both the first participant and the second participant in the lottery game (e.g., fantasy game 56) need not be human beings. Specifically, one of these participants may be a “cyber” participant. For example, instead of user 36 making a side bet with user 38, user 36 may make a side bet with “The House” or the organization running the lottery game (e.g., a company, a state or a commonwealth).

In the event that one of the participants in a sports-themed lottery game is a “cyber” participant“, the “cyber” participant may algorithmically or randomly generate a fantasy team to compete in a side bet against e.g., user 36. Alternatively, the “cyber” participant may choose a fantasy team selected by an expert working with the organization running the lottery. In the event that one of the participants in a numbers-based lottery game is a “cyber” participant“, the “cyber” participant may algorithmically or randomly generate a “quick pick” number to compete in a side bet against e.g., user 36.

General

As will be appreciated by one skilled in the art, the present disclosure may be embodied as a method, a system, or a computer program product. Accordingly, the present disclosure may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, the present disclosure may take the form of a computer program product on a computer-usable storage medium having computer-usable program code embodied in the medium.

Any suitable computer usable or computer readable medium may be utilized. The computer-usable or computer-readable medium may be, for example but not limited to, an electronic, magnetic, optical, electromagnetic, infrared, or semiconductor system, apparatus, device, or propagation medium. More specific examples (a non-exhaustive list) of the computer-readable medium may include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a transmission media such as those supporting the Internet or an intranet, or a magnetic storage device. The computer-usable or computer-readable medium may also be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory. In the context of this document, a computer-usable or computer-readable medium may be any medium that can contain, store, communicate, propagate, or transport the program for use by or in connection with the instruction execution system, apparatus, or device. The computer-usable medium may include a propagated data signal with the computer-usable program code embodied therewith, either in baseband or as part of a carrier wave. The computer usable program code may be transmitted using any appropriate medium, including but not limited to the Internet, wireline, optical fiber cable, RF, etc.

Computer program code for carrying out operations of the present disclosure may be written in an object oriented programming language such as Java, Smalltalk, C++ or the like. However, the computer program code for carrying out operations of the present disclosure may also be written in conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through a local area network/a wide area network/the Internet.

The present disclosure is described with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, may be implemented by computer program instructions. These computer program instructions may be provided to a processor of a general purpose computer/special purpose computer/other programmable data processing apparatus, such that the instructions, which execute via the processor of the computer or other programmable data processing apparatus, create means for implementing the functions/acts specified in the flowchart and/or block diagram block or blocks.

These computer program instructions may also be stored in a computer-readable memory that may direct a computer or other programmable data processing apparatus to function in a particular manner, such that the instructions stored in the computer-readable memory produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

The flowcharts and block diagrams in the figures may illustrate the architecture, functionality, and operation of possible implementations of systems, methods and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustrations, and combinations of blocks in the block diagrams and/or flowchart illustrations, may be implemented by special purpose hardware-based systems that perform the specified functions or acts, or combinations of special purpose hardware and computer instructions.

The terminology used herein is for the purpose of describing particular embodiments only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present disclosure has been presented for purposes of illustration and description, but is not intended to be exhaustive or limited to the disclosure in the form disclosed. Many modifications and variations will be apparent to those of ordinary skill in the art without departing from the scope and spirit of the disclosure. The embodiment was chosen and described in order to best explain the principles of the disclosure and the practical application, and to enable others of ordinary skill in the art to understand the disclosure for various embodiments with various modifications as are suited to the particular use contemplated.

Having thus described the disclosure of the present application in detail and by reference to embodiments thereof, it will be apparent that modifications and variations are possible without departing from the scope of the disclosure defined in the appended claims.

What is claimed is:

1. A computer-implemented method of facilitating a side bet comprising:
defining a side bet between a first participant having made a first selection in a lottery game and a second participant having made a second selection in the lottery game, wherein the side bet has a bet value;
comparing the first selection to the second selection to identify a winner of the side bet and a loser of the side bet;
obtaining the bet value from the loser of the side bet; and
providing at least a portion of the bet value to the winner of the side bet.

2. The computer-implemented method of claim 1 wherein providing at least a portion of the bet value to the winner of the side bet includes:
providing a first portion of the bet value to the winner of the side bet, and
providing a second portion of the bet value to the lottery game.

3. The computer-implemented method of claim 1 wherein comparing the first selection to the second selection includes:
comparing a first point value associated with the first selection to a second point value associated with the second selection to identify the winner of the side bet and the loser of the side bet.

4. The computer-implemented method of claim 3 wherein the lottery game is a sports-themed lottery game.

5. The computer-implemented method of claim 4 wherein:
the first point value associated with the first selection is based, at least in part, upon the performance of a first group of players within a sports league, and
the second point value associated with the second selection is based, at least in part, upon the performance of a second group of players within the sports league.

6. The computer-implemented method of claim 3 wherein the lottery game is a numbers-based lottery game.

7. The computer-implemented method of claim 6 wherein:
the first point value associated with the first selection is based, at least in part, upon the difference between the first selection and a winning selection, and
the second point value associated with the second selection is based, at least in part, upon the difference between the second selection and the winning selection.

8. A computer program product residing on a computer readable medium having a plurality of instructions stored thereon which, when executed by a processor, cause the processor to perform operations comprising:
defining a side bet between a first participant having made a first selection in a lottery game and a second participant having made a second selection in the lottery game, wherein the side bet has a bet value;
comparing the first selection to the second selection to identify a winner of the side bet and a loser of the side bet;
obtaining the bet value from the loser of the side bet; and
providing at least a portion of the bet value to the winner of the side bet.

9. The computer program product of claim 8 wherein providing at least a portion of the bet value to the winner of the side bet includes:
providing a first portion of the bet value to the winner of the side bet, and
providing a second portion of the bet value to the lottery game.

10. The computer program product of claim 8 wherein comparing the first selection to the second selection includes:
comparing a first point value associated with the first selection to a second point value associated with the second selection to identify the winner of the side bet and the loser of the side bet.

11. The computer program product of claim 10 wherein the lottery game is a sports-themed lottery game.

12. The computer program product of claim 11 wherein:
the first point value associated with the first selection is based, at least in part, upon the performance of a first group of players within a sports league, and
the second point value associated with the second selection is based, at least in part, upon the performance of a second group of players within the sports league.

13. The computer program product of claim 10 wherein the lottery game is a numbers-based lottery game.

14. The computer program product of claim 13 wherein:
the first point value associated with the first selection is based, at least in part, upon the difference between the first selection and a winning selection, and
the second point value associated with the second selection is based, at least in part, upon the difference between the second selection and the winning selection.

15. A computing system including a processor and memory configured to perform operations comprising:
defining a side bet between a first participant having made a first selection in a lottery game and a second participant having made a second selection in the lottery game, wherein the side bet has a bet value;
comparing the first selection to the second selection to identify a winner of the side bet and a loser of the side bet;
obtaining the bet value from the loser of the side bet; and
providing at least a portion of the bet value to the winner of the side bet.

16. The computing system of claim 15 wherein providing at least a portion of the bet value to the winner of the side bet includes:
providing a first portion of the bet value to the winner of the side bet, and
providing a second portion of the bet value to the lottery game.

17. The computing system of claim 15 wherein comparing the first selection to the second selection includes:
comparing a first point value associated with the first selection to a second point value associated with the second selection to identify the winner of the side bet and the loser of the side bet.

18. The computing system of claim 17 wherein the lottery game is a sports-themed lottery game.

19. The computing system of claim 18 wherein:
the first point value associated with the first selection is based, at least in part, upon the performance of a first group of players within a sports league, and
the second point value associated with the second selection is based, at least in part, upon the performance of a second group of players within the sports league.

20. The computing system of claim 17 wherein the lottery game is a numbers-based lottery game.

21. The computing system of claim 20 wherein:
the first point value associated with the first selection is based, at least in part, upon the difference between the first selection and a winning selection, and
the second point value associated with the second selection is based, at least in part, upon the difference between the second selection and the winning selection.
